(19) United States
(12) Patent Application Publication
(10) Pub. No.: US 2012/0167171 A1
(43) Pub. Date: Jun. 28, 2012

(54) Voice-capable system and method for authentication query recall and reuse prevention

(75) Inventors: Edward K.Y. Jung, (US); Royce A. Levien, (US); Robert W. Lord, (US); Mark A. Malamud, (US); John D. Rinaldo, JR., Bellevue, WA (US)

(73) Assignee: Searete LLC, a limited liability corporation of the State of Delaware

(21) Appl. No.: 13/134,697

(22) Filed: Jun. 14, 2011

Related U.S. Application Data
(63) Continuation-in-part of application No. 11/291,120, filed on Nov. 30, 2005, now abandoned.

(51) Int. Cl. G06F 21/00

(52) U.S. Cl. 726/2

(57) ABSTRACT

A system and method for use with a voice-capable system, includes but is not limited to a method including receiving an authentication request by the voice-capable system from a user computationally networked to the voice-capable system, and determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed.

### TECHNICAL FIELD

The present application relates generally to security systems.

### SUMMARY

In one aspect, a method for use with a voice-capable system includes but is not limited to receiving an authentication request by the voice-capable system from a user computationally networked to the voice-capable system; and determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed. In addition to the foregoing, other method aspects are described in the claims, drawings, and text forming a part of the present application.

In another aspect, a method for use with a voice-capable system includes but is not limited to receiving an authentication request by the voice-capable system from a user computationally networked to the voice-capable system; and determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid. In addition to the foregoing, other method aspects are described in the claims, drawings, and text forming a part of the present application.

In another aspect, a computer program product includes but is not limited to a signal bearing medium bearing at least one of one or more instructions for receiving an authentication request by the voice-capable system from a user computationally networked to the voice-capable system; and one or more instructions for determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed. In addition to the foregoing, other computer program product aspects are described in the claims, drawings, and text forming a part of the present application.

In another aspect, a computer program product includes but is not limited to a signal bearing medium bearing at least one of one or more instructions for receiving an authentication request by the voice-capable system from a user computationally networked to the voice-capable system; and one or more instructions for determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid. In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a voice-capable system includes but is not limited to a processor, an audio input and/or output circuitry coupled to the processor, a memory coupled to the processor, and a security module coupled to the processor, the security module configured to implement a secure protocol, the secure protocol configured to implement an automated system with one or more questions related to security/authentication, the security module configured to include an access module for receiving an authentication request by the voice-capable system from a user computationally networked to the voice-capable system, a time authentication module for determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed, and/or a discrete parameter authentication generation module for determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid. In addition to the foregoing, other voice-capable system aspects are described in the claims, drawings, and text forming a part of the present application.

In addition to the foregoing, various other method, system, and/or computer program product aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of a network environment that supports the claimed subject matter of the present application;

FIG. 3 is a block diagram of a communication device appropriate for embodiments of the subject matter of the present application;

FIGS. 4A, 4B and 4C illustrate a flow diagram of a method in accordance with an embodiment of the subject matter of the present application; and

FIGS. 5A and 5B illustrate another flow diagram of a method in accordance with an embodiment of the subject matter of the present application.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

According to William Crossman, Founder/Director of CompSpeak 2050 Institute for the Study of Talking Computers and Oral Cultures, VIVOs, (e.g., voice-in/voice-out computers that may operate using visual displays) may make written language obsolete. VIVOs potentially can perform the functions of written language without requiring people to learn to read and write and, therefore, enable illiterate people, using VIVOs, to access the stored information.

Opening the doors for potentially billions of people to electronically-stored data presents a host of issues related to security and/or authentication. More particularly, according to Crossman, billions of illiterate people will be able to access data previously available only to the computer literate. The increase in the number of people with access to the Internet will increase the need for security systems that address the enhanced security risk. Moreover, VIVO technology will increase the number of security systems reliant on voice commands and subject users to security risks present with voice-related systems.

To combat the security risk inherent in a VIVO system, embodiments herein present authentication and/or security solutions practical for voice-related security.

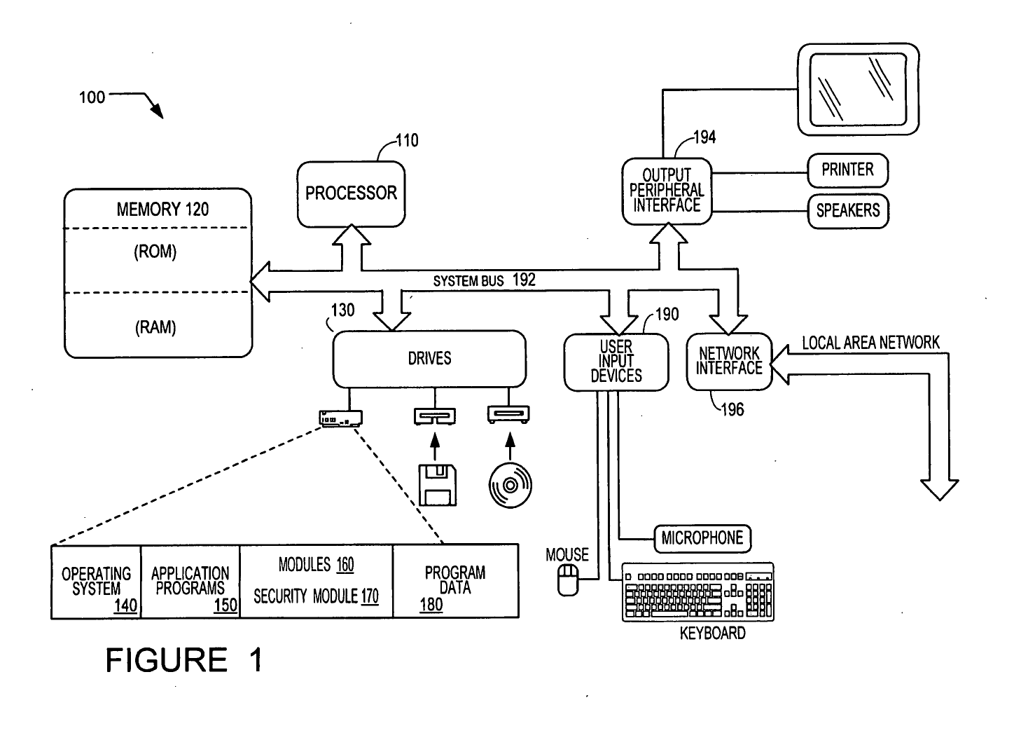

With reference to FIG. 1, depicted is an exemplary computing system for implementing embodiments. FIG. 1 includes a computer 100, which could be a VIVO-capable computer, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, such as security module 170 and program data 180. Computer 100 further includes user input devices 190 through which a user may enter commands and data. Input devices can include an electronic digitizer, a microphone, a keyboard and pointing device, commonly referred to as a mouse, trackball or touch pad. Other input devices may include a joystick, game pad, satellite dish, scanner, or the like. In one or more embodiments, user input devices 190 are VIVO enabling devices, enabling a user to provide voice activated responses and/or questions.

These and other input devices can be connected to processor 110 through a user input interface that is coupled to a system bus, but may be connected by other interface and bus structures, such as a parallel port, game port or a universal serial bus (USB). Computers such as computer 100 may also include other peripheral output devices such as speakers, which may be connected through an output peripheral interface 194 or the like. More particularly, output devices can include VIVO enabling devices capable of providing voice output in response to voice input.

Computer 100 may operate in a networked environment using logical connections to one or more computers, such as a remote computer connected to network interface 196. The remote computer may be a personal computer, a server, a router, a network PC, a peer device or other common network node, and can include many or all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or adapter. When used in a WAN networking environment, computer 100 typically includes a modem or other means for establishing communications over the WAN, such as the Internet. It will be appreciated that other means of establishing a communications link between the computers may be used.

According to one embodiment, computer 100 is connected in a networking environment such that the processor 110 and/or security module 170 determine whether incoming data follows a secure protocol. The incoming data can be from a VIVO communication device or from another data source. The secure protocol can be code stored in memory 120. For example, processor 110 can determine whether an incoming call is from a VIVO, determine that a secure protocol is necessary and apply an appropriate authentication.

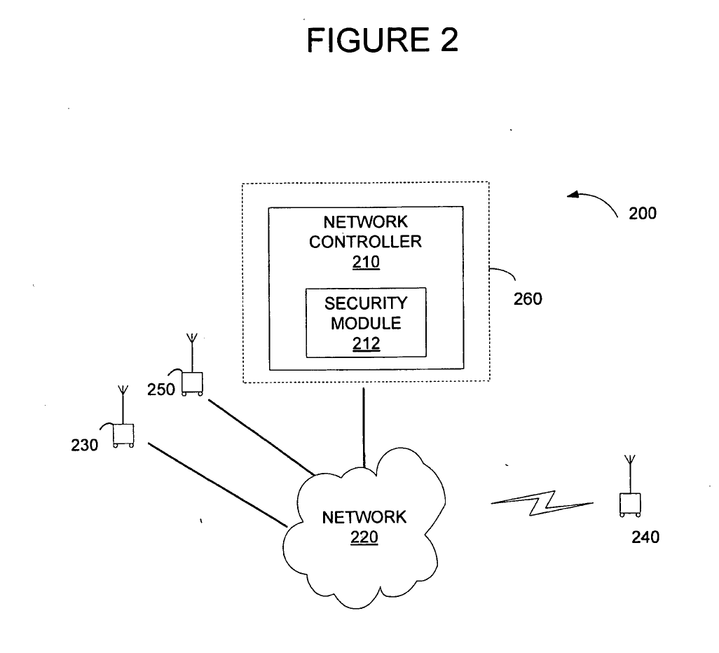

Referring now to FIG. 2, illustrated is an exemplary block diagram of a system 200 capable of being operable with VIVO computer systems and interacting with a VIVO-type computer system. System 200 is shown including network controller 210, a network 220, and one or more communication devices 230, 240, and 250. Communication devices 230, 240, and 250 may include telephones, wireless telephones, cellular telephones, personal digital assistants, computer terminals or any other devices that are capable of sending and receiving data.

Network controller 210 is connected to network 220. Network controller 210 may be located at a base station, a service center, or any other location on network 220 and be included in a device 260. Network 220 may include any type of network that is capable of sending and receiving communication signals, including VIVO-type signals. For example, network 220 may include a data network, such as the Internet, an intranet, a local area network (LAN), a wide area network (WAN), a cable network, and other like communication systems. Network 220 may also include a telecommunications network, such as a local telephone network, long distance telephone network, cellular telephone network, satellite communications network, cable television network and other like communications systems that interact with computer systems. Network 220 may include more than one network and may include a plurality of different types of networks. Thus, network 220 may include a plurality of data networks, a plurality of telecommunications networks, a combination of data and telecommunications networks, and other like communication systems.

In operation, one of the communication devices 230, 240, or 250, may attempt a communication with a receiving communication device 260. The communication can be routed through network 220 and network controller 210 to the receiving communication device 260. In another example, a call originator communication device 230 may attempt a call to a call recipient communication device 240. In an embodiment, controller 210 is a VIVO-enabled controller such that an audible format may be a speech format. According to an embodiment, controller 210 can include a security module 212 that can poll the caller and a call recipient communication device 240 during call setup to pose authentication questions to secure a connection. For example, a call could be to a bank or other recipient with sensitive data requiring security.

Controller 210 can alter the format of the call by performing speech-to-text conversion on the call when controller 210 determines the format of the call requires a format change. Controller 210 can additionally alter the format of the call by performing text-to-speech conversion on the call when controller 210 determines the format of the call requires a format change. Controller 210 can then send the call in an appropriate format to the call recipient 240. In one embodiment, controller 210 is a VIVO-enabled controller that alters speech to text or speech to computer code in accordance with the requirements of a VIVO.

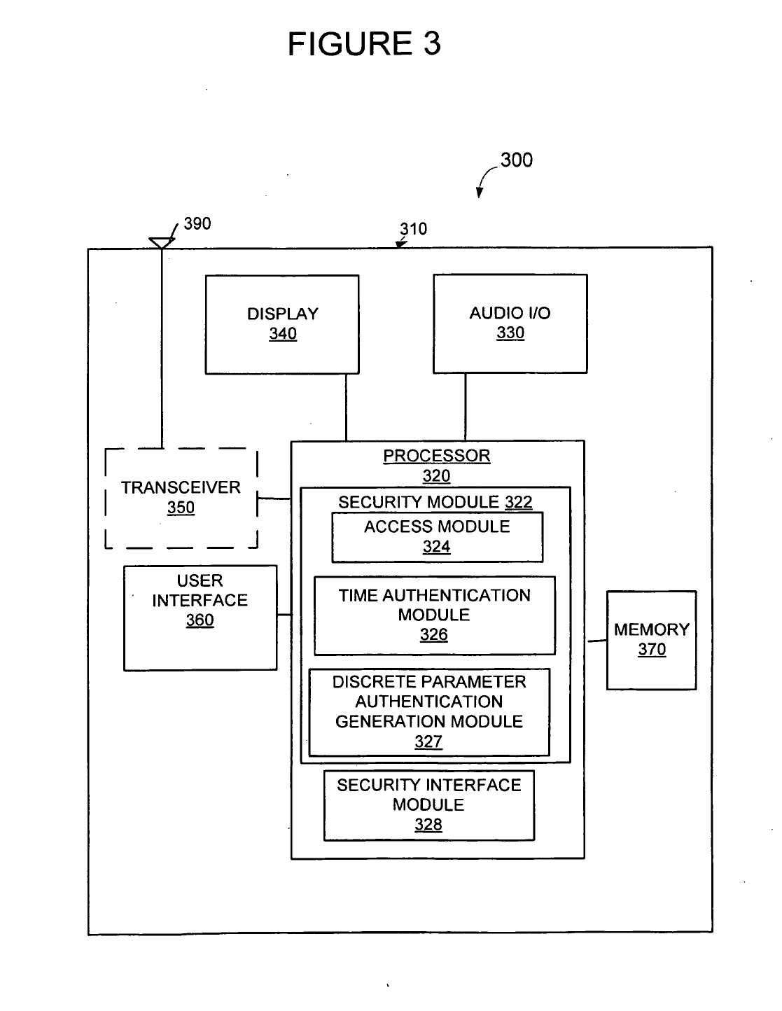

FIG. 3 is an exemplary block diagram of a communication device 300, such as communication device 230 or 240 according to an embodiment, (e.g. FIG. 2). Communication device 300 can include a housing 310, a processor 320, audio input and output circuitry 330 coupled to processor 320, a display 340 coupled to processor 320, a user interface 360 coupled to processor 320 and a memory 370 coupled to processor 320. According to an embodiment, processor 320 includes security module 322. Security module 322 may be hardware coupled to the processor 320. Alternatively, security module 322 could be located within processor 320, or located in software located in memory 370 and executed by processor 320, or any other type of module. Memory 370 can include a random access memory, a read only memory, an optical memory, a subscriber identity module memory, or any other memory that can be coupled to a communication device. Display 340 can be a liquid crystal display (LCD), a light emitting diode (LED) display, a plasma display, or any other means for displaying information. Audio input and output circuitry 330 can include a microphone, a speaker, a transducer, or any other audio input and output circuitry. User interface 360 can include a keypad, buttons, a touch pad, a joystick, an additional display, or any other device useful for providing an interface between a user and an electronic device.

Processor 320 can be configured to control the functions of communication device 300. Communication device 300 can send and receive signals across network 220 wireless technologies such as using a transceiver 350 coupled to antenna 390. Alternatively, communication device 300 can be a device relying on non-wireless technologies such as twisted pair technology and not utilize transceiver 350.

According to an embodiment, a user can use either the user interface 360 for input and output of information to and from communication device 300 or use input and output using the audio input and output circuitry 330. Data received by communication device 300 can be displayed on display 340 and/or provided audibly through audio input and output circuitry 330. Communication device 300 can operate as a VIVO when operated in a fully audible format. For example, VIVO applications can be stored on memory 370 and processed by processor 320.

According to one embodiment, the processor 320 and/or security module 322 can determine whether an incoming call follows a secure protocol. The secure protocol can be code stored in memory 370. For example, processor 320 can determine an incoming call is from a VIVO, determine that a secure protocol is necessary and apply an appropriate authentication. Conversely, processor 320 and/or security module 322 can determine that an outgoing call should follow a secure protocol and implement the secure protocol.

According to an embodiment, security module 322 is configured with modules for implementing embodiments disclosed herein. More particularly, security module 322 can be configured with access module 324 which can be configured for accessing by the voice-capable system of one or more entities computationally networked to the voice-capable system such as for receiving an authentication request by the voice-capable system from a user computationally networked to the voice-capable system. The entities computationally networked to the voice-capable system can be entities with different security requirements and required authentications. For example, an entity computationally networked to the voice-capable system can be within a same computational network, such as a local area network (LAN), or the like. Conversely, an entity computationally-networked can be networked through an internet connection but require firewall access or other security measures to connect.

Security module 322 can further include time authentication module 326 for determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed.

Security module 322 can further include discrete parameter authentication generation module 327 for determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid. The discrete parameter authentication generation module can enable the communication device 300 or an entity networked to the voice-capable system. Security module 322 is shown further including security interface module 328 configured to enable modules 324, 326 and 327 to interface with computationally networked entities.

In one embodiment, either or both computer 100 and communication device 300 operate as VIVOs that are capable of implementing a secure protocol for incoming and/or outgoing audible data and/or speech. The secure protocol, in one embodiment, implements a user-centric question and answer to authenticate one or both of incoming and outgoing data when an auditory format is detected. For example, if computer 100 or communication device 300 is used to communicate with a bank, the bank could implement a secure protocol by operating a computer 100 with a security module or a communication device 300 with a security module. Likewise, the bank could operate via a secure network such as a network described in FIG. 2, and implement a secure protocol via network controller 210 implementing a security protocol via a security module.

In one embodiment, the security module is configured with processor (e.g., in either computer 100, communication device 300, or in a network controller 210) implementing a secure protocol, the secure protocol configured to implement authentication. More particularly, the security module could include a question module configured to serve as an automated system with one or more questions related to security/authentication, the security module configured to include an access module for receiving an authentication request by the voice-capable system from a user computationally networked to the voice-capable system, and an authentication generation module for determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed.

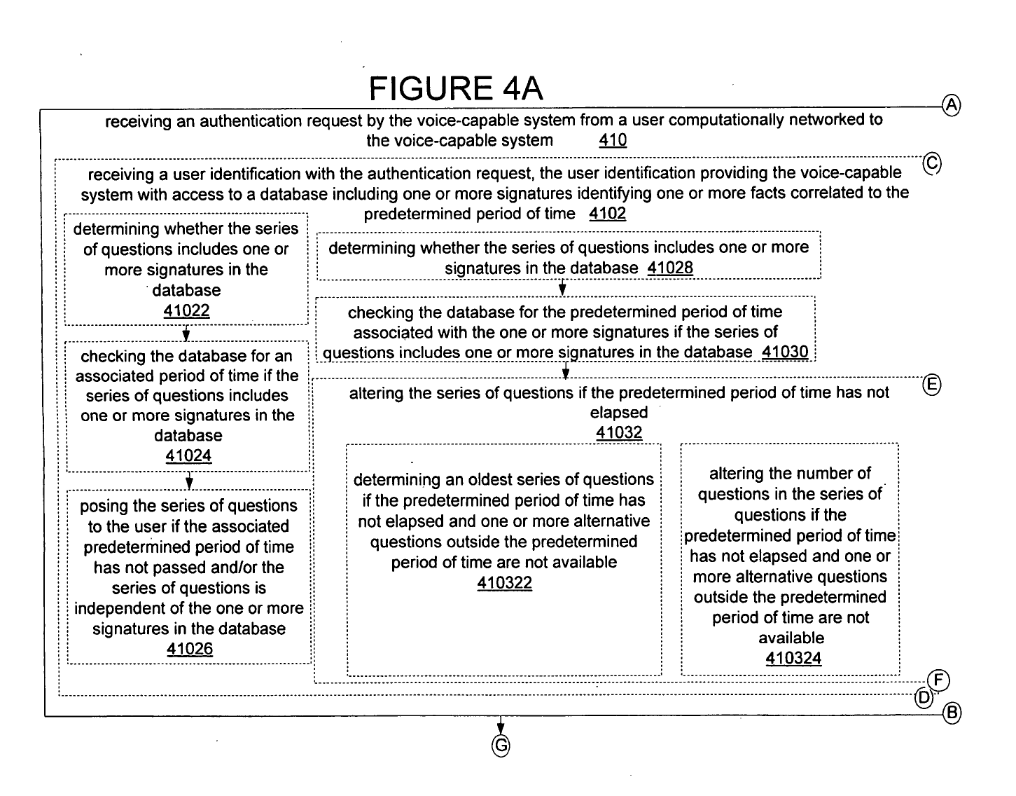

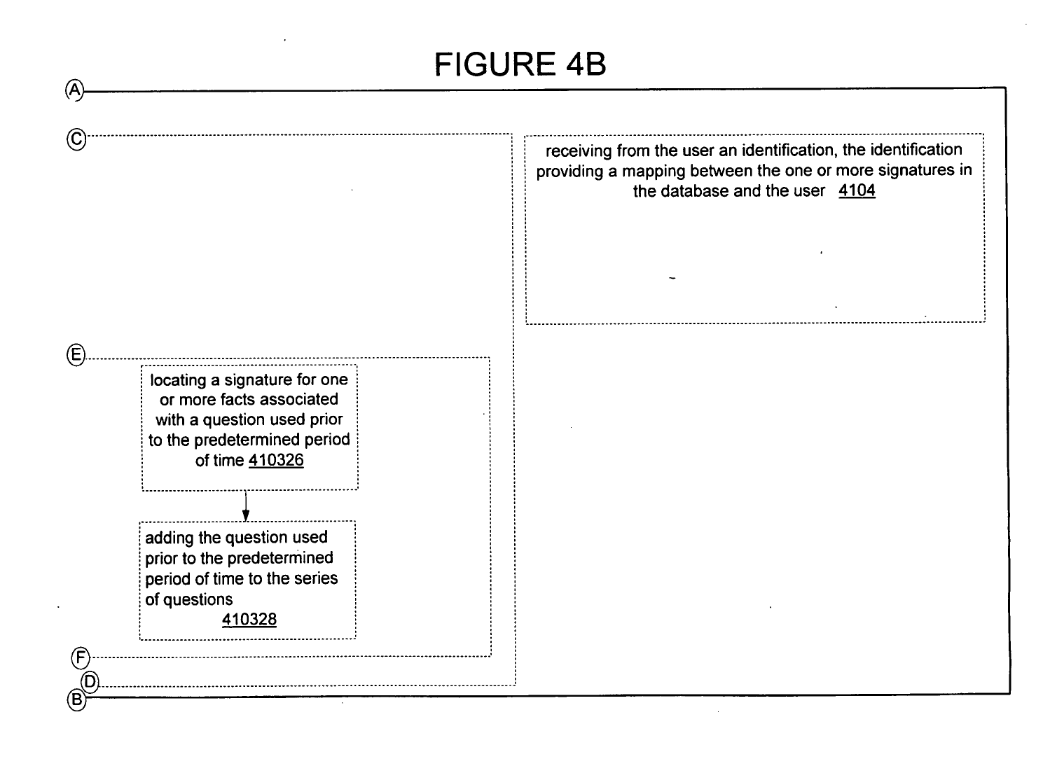

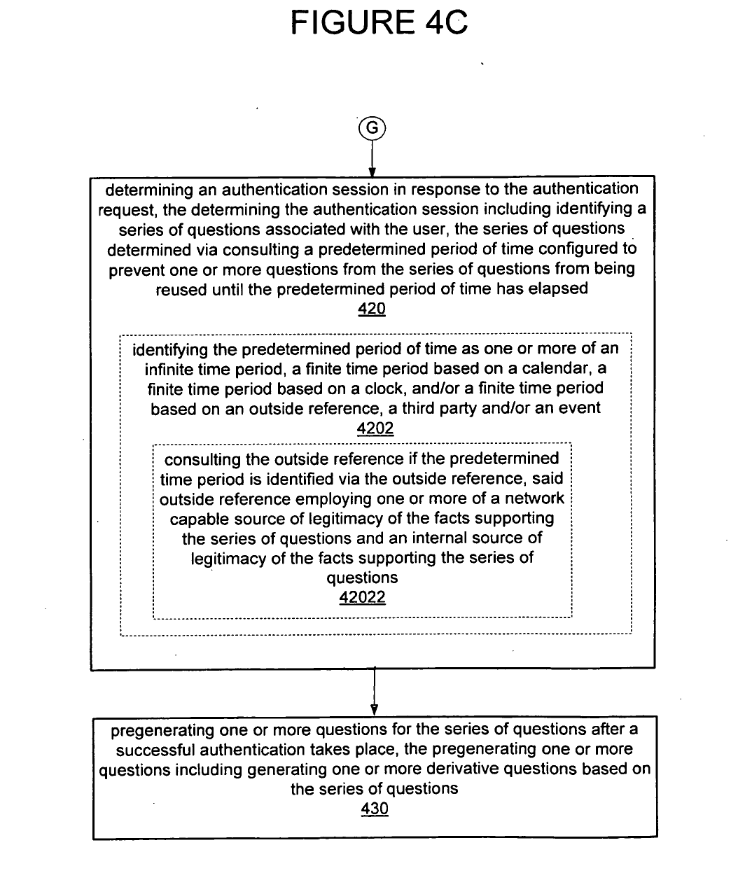

Referring now to FIGS. 4A, 4B and 4C, an exemplary flow diagram illustrates the operation of the processor 320 and/or security module 322 and/or network controller 210 according to an embodiment. One of skill in the art with the benefit of the present disclosure will appreciate that act(s) can be taken by security module 322, network controller 210, processor 110, and/or security module 170. The acts are generally referred to as being taken by a security processor.

FIGS. 4A, 4B and 4C provide methods for use with a voice-capable system, such as a system capable of authentication. The authentication could be via a telephone to a security processor from a VIVO or the like. For example, a bank can receive a request to authenticate a customer, or the like. A security processor can determine that an authentication session is required. For example, the determination can be a determination by a bank that a user wishes to log into the bank. The determination can include a determination that a user is using a telephone to log into the bank via audible-only methods of communication. For example, a bank can operate via a network capable of accepting auditory communications from a user and have a computer, such as computer 100, or network controller 210, respond with auditory communications back to the user.

Block 410 provides for receiving an authentication request by the voice-capable system from a user computationally networked to the voice-capable system (e.g., security module 212 or security module 322 receiving an authentication request from a user, not shown, via transceiver 350 or user interface 360 or the like from a network such as network 220).

Depicted within block 410 is optional block 4102, which provides for receiving a user identification with the authentication request, the user identification providing the voice-capable system with access to a database including one or more signatures identifying one or more facts correlated to the predetermined period of time (e.g., security module 212 or security module 322 receiving a user identification with an authentication request from a user, not shown, via transceiver 350 or user interface 360 or the like from a network such as network 220).

Also depicted within block 410 is optional block 4104, shown in FIG. 4B, which provides for receiving from the user an identification, the identification providing a mapping between the one or more signatures in the database and the user (e.g., security module 212 or security module 322 receiving an identification from a user via either transceiver 350 or user interface 360 that provides a mapping to a database in memory 370 under the control of network controller 210). The signatures can be configured to enable efficient mapping between facts and questions formed from the facts. Further, the signatures can enable forming new questions from different combinations of facts. The signatures can be efficiently represented using binary numbers, codes or the like.

Depicted within block 4102, are blocks 41022, 41024 and 41026, which provide an optional method for receiving a user identification including, in block 41022, determining whether the series of questions includes one or more signatures in the database (e.g., processor 320 determining whether the series of questions includes one or more signatures as stored in memory 370). The signatures can include an identification of or more facts peculiar to the user that can be included within an authentication question, combined to form an authentication question or independently form the basis of an authentication question. Block 41024 provides for checking the database for an associated period of time if the series of questions includes one or more signatures in the database (e.g., checking a database in memory 370 for an associated period of time). Thus, if the signatures are located in a time keeping database or are facts that could expire, the database could be configured to correlate the signatures with dates of expiration and notify a security system that the expiration date for an authentication is imminent or the like. Block 41026 provides for posing the series of questions to the user if the associated predetermined period of time has not passed and/or the series of questions is independent of the one or more signatures in the database (e.g., posing the series of questions via user interface 360 or over network 220 to a user, not shown, if the period of time has not passed or the series of questions has no correlate in memory 370). For example, if the database holds only those signatures that are correlated to an expiration date, and the expiration date has not occurred, the series of questions would be posed. Likewise, if the expiration date for the questions is in the future, the series of questions would be posed.

Block 4102 also provides for an alternative method expanding on the receiving a user identification shown in blocks 41028, 41030 and 41032. More particularly, block 41028 provides for determining whether the series of questions includes one or more signatures in the database (e.g., checking a database in memory 370 for signatures). Block 41030 provides for checking the database for the predetermined period of time associated with the one or more signatures if the series of questions includes one or more signatures in the database (e.g., checking a database in memory 370 for a predetermined period of time associated with signatures in the database). The predetermined period of time associated with the one or more signatures can be a predetermined time period that prevents questions from being reused until the risk of an authentication security breach is determined to be low or negligible. Block 41032 provides for altering the series of questions if the predetermined period of time has not elapsed (e.g., processor 320 altering the series of questions according to time authentication module 326 direction). If the period of time indicated in the database provides expiration data for signatures in the series of questions, and each signature is within the period of time associated, the questions can be deemed appropriate for authentication purposes. However, to protect a user and a system for future authentications, the series of questions can be altered for a next authentication by reformulating the questions using the same or different signatures. For example, signatures related to personal information about the user such as age, address and the like can be combined with other signatures related to a recent credit card purchase or internet transaction that could be recalled by the user to formulate an altered series of questions and provide a more secure authentication session.

Depicted within block 41032 is block 410322 which provides that the altering the series of questions if the predetermined period of time has not elapsed can include determining an oldest series of questions if the predetermined period of time has not elapsed and one or more alternative questions outside the predetermined period of time are not available (e.g., processor 320 can alter the series of questions according to predetermined requirements provided via time authentication module 326). For example, when altering the series of questions, using an oldest series of questions from a database instead of a more recently used series of questions can be used to make the series of questions more secure. Further, alternative questions that are not included in the oldest series of questions from the database but are nonetheless relevant and meet one or more requirement parameters of time authentication module 326 can be included, as will be appreciated by one of skill in the art with the benefit of the present application.

Also depicted within block 41032 is block 410324 which provides for altering a number of questions in the series of questions if the predetermined period of time has not elapsed and one or more alternative questions outside the predetermined period of time are not available (e.g., processor 320 altering the series of questions according to requirements provided via time authentication module 326 and questions stored in memory 370). More particularly, the altering the questions can include either increasing or decreasing the number of questions in the series of questions if the predetermined period of time has not elapsed. Altering the number of questions can beneficially decrease the possibility of a breach of security by potential eavesdroppers expecting a same number of questions to be asked at each authentication session.

Block 41032 also depicts blocks 410326 and 410328. Block 410326 provides for locating a signature for one or more facts associated with a question used prior to the predetermined period of time (e.g. locating by processor 320 under the control of security module 322 operating with memory 370 to locate the signature). The signature can be associated with one or more facts, such that a code or binary number is associated with the one or more facts to make searching for the facts more efficient. Block 410328 provides for adding the question used prior to the predetermined period of time to the series of questions (e,g, processor 320 adding the question according to direction of time authentication module 326). For example, if a predetermined amount of time is determined to be one month, and the month has not passed, to prevent an eavesdropper from being able to predict the questions to be asked during an authentication, the questions asked in a prior month can be mixed in with current questions.

Block 420, shown in FIG. 4 C, provides for determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed (e.g., processor 320 determining an authentication session, or security module 322 determining an authentication session in response to an authentication request received via either user interface 360 or transceiver 350, and consulting a series of questions stored in memory 370).

Depicted within block 420 is optional block 4202, which provides for identifying the predetermined period of time as one or more of an infinite time period, a finite time period based on a calendar, a finite time period based on a clock, and/or a finite time period based on an outside reference, a third party and/or an event (e.g., time authentication module identifying the period of time or discrete parameter authentication generation module 327 identifying an event, outside reference or third party or the like). For example, an entity can determine that a safe authentication period of time can require that questions expire after a certain date, an hour or the like. For less secure systems, the questions may not need changing so an infinite period of time may be allowed. Alternatively, a finite period of time can be for one-time authentications. Also, for limited authentications, for example, a third party can determine the period of time by referring to other sources. In one embodiment, an event can determine the period of time. For example, if a user alters a status with an entity, thereby requiring more or less security, the period of time can be a function of the security associated with the status. Thus, for example, a bank with different levels of protection depending on the amount invested would have user authentication with less time between question altering than a user with a minimal investment.

Block 4202 includes optional block 42022 which provides for consulting the outside reference if the predetermined time period is identified via the outside reference, said outside reference employing one or more of a network capable source of legitimacy of the facts supporting the series of questions and an internal source of legitimacy of the facts supporting the series of questions (e.g. processor 320 can consult an outside reference via transceiver 350, or security module 212 can consult an outside reference via network 220 if a determination is made that the predetermined time period is identified via the outside reference). The outside reference can include an entity such as device 260 or the like with an internal security module 212. For example, an outside reference could be reached via an internal LAN or other network to determine a period of time. The outside reference can use different methods for determining a period of time appropriate for a user.

Block 430 provides for pregenerating one or more questions for the series of questions after a successful authentication takes place, the pregenerating one or more questions including generating one or more derivative questions based on the series of questions (e.g., processor 320 pregenerating questions in accordance with direction from access module 324 or another source within security module 322 or the like). The pregenerating can include restructuring questions to provide different combinations of facts and new facts as determined appropriate for a user. The pregenerating, for example, can include storing the generated questions for future use. The facts used in the pregeneration can be associated with the signatures such that new combinations of facts are used to pregenerate the questions.

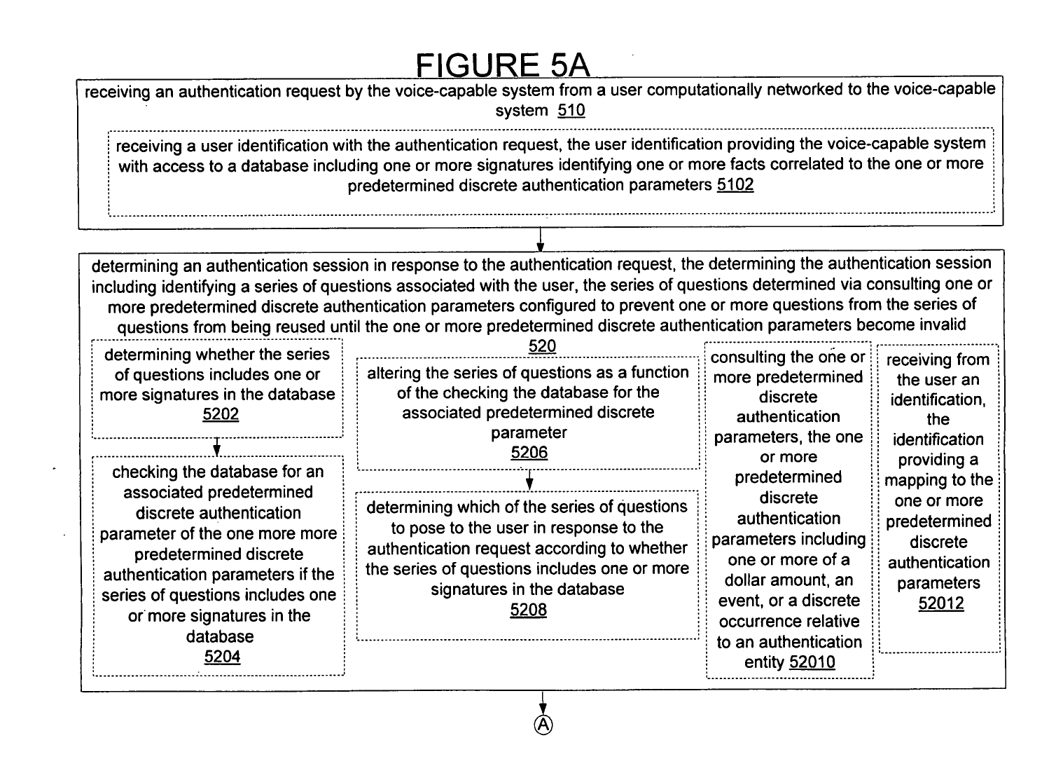

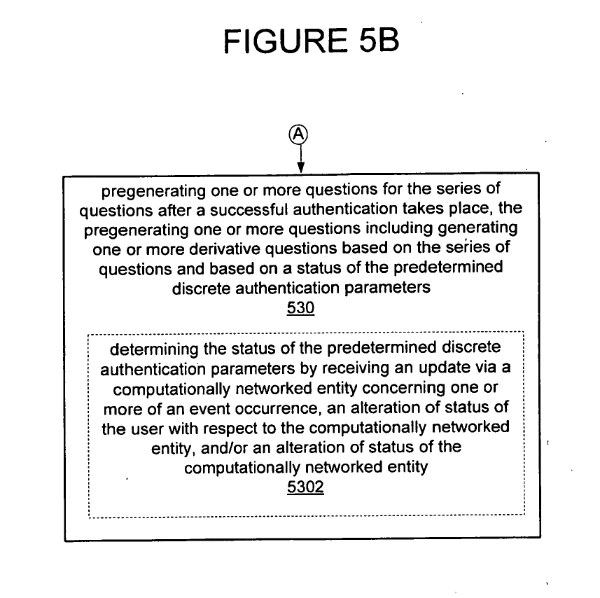

In another embodiment, a method is provided that does not require a predetermined period of time for determination of validity of questions. The method is described with respect to FIGS. 5A and 5B. More particularly, block 510 provides for receiving an authentication request by the voice-capable system from a user computationally networked to the voice-capable system (e.g., security module 212 or security module 322 receiving an authentication request from a user, not shown, via transceiver 350 or user interface 360 or the like from a network such as network 220).

Depicted within block 510, block 5102 provides for receiving a user identification with the authentication request, the user identification providing the voice-capable system with access to a database including one or more signatures identifying one or more facts correlated to the one or more predetermined discrete authentication parameters (e.g., security module 212 or security module 322 receiving a user identification with the authentication request from a user, not shown, via transceiver 350 or user interface 360 or the like from a network such as network 220).

For example, a user requesting authentication can have a user identification that enables the voice-capable system to identify signatures in a database. The signatures that identify facts can be correlated to parameters that determine when the parameters should affect an authentication procedure.

Block 520 provides for determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid (e.g., security module 212, security module 322 or processor 320 determining an authentication session with a user, not shown, via identifying a series of questions received from memory 370 or from a network such as network 220).

In an embodiment, the authentication session includes an entity questioning a user to validate him or herself to the entity based on questions that relate to the user via some discrete authentication parameters. Discrete for purposes of this embodiment refers to non-time dependent data that would have a bearing on the security level required for authentication. For example, a bank typically provides customers with different levels of banking accounts dependent on the amount of money to be invested in the account. Free checking accounts and the like are typically provided to customers who have a certain amount of funds invested. The more funds invested in an account, the more secure a bank might provide for access to accounts. Thus, for example, a discrete authentication parameter could include the amount of funds a user has invested in the bank. When a user reaches a certain dollar level of investment, i.e., a discrete authentication parameter, the series of questions that are prevented from reuse could be altered, discarded or the like. Conversely, if a user has less investment than required for heightened security, the bank could allow reuse of questions because the risk of loss has lessened.

Depicted in block 520 are series of blocks 5202, 5204, 5206 and 5208. Block 5202 provides for determining whether the series of questions includes one or more signatures in the database (e.g. processor 320 determining whether the series of questions in memory 370 include signatures in a database in memory 370). The signatures can be associated with facts that can be in one or more questions in a series of questions. Block 5204 provides for checking the database for an associated predetermined discrete authentication parameter of the one or more predetermined discrete authentication parameters if the series of questions includes one or more signatures in the database (e.g., checking a database within memory 370 for a predetermined discrete authentication parameter from discrete parameter authentication generation module 327). The database can include signatures and correlated parameters associated with the signatures. Block 5206 provides for altering the series of questions as a function of the checking the database for the associated predetermined discrete parameter (e.g., processor 320 altering the series of questions as a function of checking a database within memory 370). Thus, for example, if the database indicates that the predetermined discrete parameters indicate that one or more of the series of questions are invalid due to nonexistence of an outside entity, nonexistence of an account or invalidity of an account or the like, then processor 320 can be configured to operate on the series of questions to alter the series of questions. Block 5208 provides for determining which of the series of questions to pose to the user in response to the authentication request according to whether the series of questions includes one or more signatures in the database (e.g., processor 320 determining which of the series of questions from memory 370 to pose to a user, not shown, according to signatures in a database in memory 370).

Also depicted in block 520 is optional block 52010. Block 52010 provides for consulting the one or more predetermined discrete authentication parameters, the one or more predetermined discrete authentication parameters including one or more of a dollar amount, an event, and/or a discrete occurrence relative to an authentication entity (e.g., processor 320 consulting the one or more predetermined discrete authentication parameters found in discrete parameter authentication generation module 327). For example, the determination of when a question in the series of questions should be altered can depend on whether an event occurs. For example, a user could alter his association with the authentication entity and that could trigger a new authentication security level. One type of association with the authentication entity could be a government security level or the like. Another association with the authentication entity could be a security level associated with the type of property being protected by the authentication. A dollar amount or value of the property secured could determine when questions should change. For example, a securities account that is used to purchase options or riskier investments could trigger a new authentication security level and new questions as compared to a securities account used for mutual fund investments or the like.

Block 520 further includes optional block 52012 which provides for receiving from the user an identification, the identification providing a mapping to the one or more predetermined discrete authentication parameters (e.g., receiving via user interface 360 or transceiver 350 or network 220 an identification from a user, not shown, wherein the identification can provide a mapping to a location in memory 370 or the like or to a location in discrete parameter authentication generation module 327). For example, a database could be configured to include user identification that can be mapped to parameters that would indicate occurrences, situations and the like that would determine when questions in the series of authentication questions should be altered for security purposes.

Block 530 provides for pregenerating one or more questions for the series of questions after a successful authentication takes place, the pregenerating one or more questions including generating one or more derivative questions based on the series of questions and based on a status of the predetermined discrete authentication parameters (e.g., processor 320 pregenerating questions in accordance with direction from discrete parameter authentication generation module 327). For example, a voice-capable system could be configured so that questions are pregenerated to prevent a lack of questions in the series of questions. The pregenerating the questions can take place offline, i.e., after a user is no longer connected to the voice-capable system or can take place during an authentication session.

Depicted within block 530 is block 5302, which provides for determining the status of the predetermined discrete authentication parameters by receiving an update via a computationally networked entity concerning one or more of an event occurrence, an alteration of status of the user with respect to the computationally networked entity, and/or an alteration of status of the computationally networked entity (e.g., processor 320 determining status of the discrete authentication parameters by receiving an update from an entity such as one or more of entities 230, 240, 250 and 260 over network 220 with respect to the status of a user, not shown). The computationally networked entity can be an internal source to the voice-capable system or an outside entity. In either case, the voice-capable system can be configured to receive a status of the user such that a determination of a discrete authentication parameter and the validity of the authentication questions can be determined.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A method for use with a voice-capable system, the method comprising:
receiving an authentication request by the voice-capable system from a user computationally networked to the voice-capable system; and
determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed.

2. The method of claim 1 wherein the receiving an authentication request by the voice-capable system from a user computationally networked to the voice-capable system includes:
receiving a user identification with the authentication request, the user identification providing the voice-capable system with access to a database including one or more signatures identifying one or more facts correlated to the predetermined period of time.

3. The method of claim 2 wherein the receiving a user identification with the authentication request, the user identification providing the voice-capable system with access to a database including one or more signatures identifying one or more facts correlated to the predetermined period of time includes:
determining whether the series of questions includes one or more signatures in the database;
checking the database for an associated period of time if the series of questions includes one or more signatures in the database; and
posing the series of questions to the user if the associated predetermined period of time has not passed and/or the series of questions is independent of the one or more signatures in the database.

4. The method of claim 2 wherein the receiving a user identification with the authentication request, the user identification providing the voice-capable system with access to a database including one or more signatures identifying one or more facts correlated to the predetermined period of time includes:
determining whether the series of questions includes one or more signatures in the database; checking the database for the predetermined period of time associated with the one or more signatures if the series of questions includes one or more signatures in the database; and
altering the series of questions if the predetermined period of time has not elapsed.

5. The method of claim 4 wherein the altering the series of questions if the predetermined period of time has not elapsed includes:
determining an oldest series of questions if the predetermined period of time has not elapsed and one or more alternative questions outside the predetermined period of time are not available.

6. The method of claim 4 wherein the altering the series of questions if the predetermined period of time has not elapsed includes:
altering a number of questions in the series of questions if the predetermined period of time has not elapsed and one or more alternative questions outside the predetermined period of time are not available.

7. The method of claim 4 wherein the altering the series of questions if the predetermined period of time has not elapsed includes:
locating a signature for one or more facts associated with a question used prior to the predetermined period of time; and
adding the question used prior to the predetermined period of time to the series of questions.

8. The method of claim 1 wherein the receiving an authentication request by the voice-capable system from a user computationally networked to the voice-capable system includes:
receiving from the user an identification, the identification providing a mapping between the one or more signatures in the database and the user.

9. The method of claim 1 wherein the determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed includes:
identifying the predetermined period of time as one or more of an infinite time period, a finite time period based on a calendar, a finite time period based on a clock, and/or a finite time period based on an outside reference, a third party and/or an event.

10. The method of claim 9 wherein the identifying the predetermined period of time as one or more of an infinite time period, a finite time period based on a calendar, a finite time period based on a clock, and/or a finite time period based on an outside reference, a third party and/or an event includes:
consulting the outside reference if the predetermined time period is identified via the outside reference, said outside reference employing one or more of a network capable source of legitimacy of the facts supporting the series of questions and an internal source of legitimacy of the facts supporting the series of questions.

11. The method of claim 1 further comprising:
pregenerating one or more questions for the series of questions after a successful authentication takes place, the pregenerating one or more questions including generating one or more derivative questions based on the series of questions.

12. A method for use with a voice-capable system, the method comprising:
receiving an authentication request by the voice-capable system from a user computationally networked to the voice-capable system; and
determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid.

13. The method of claim 12 wherein the receiving an authentication request by the voice-capable system from a user computationally networked to the voice-capable system includes:
receiving a user identification with the authentication request, the user identification providing the voice-capable system with access to a database including one or more signatures identifying one or more facts correlated to the one or more predetermined discrete authentication parameters.

14. The method of claim 12 wherein the determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid includes:
determining whether the series of questions includes one or more signatures in the database; and checking the database for an associated predetermined discrete authentication parameter of the one or more predetermined discrete authentication parameters if the series of questions includes one or more signatures in the database.

15. The method of claim 14 further comprising:
altering the series of questions as a function of the checking the database for the associated predetermined discrete parameter.

16. The method of claim 14 further comprising:
determining which of the series of questions to pose to the user in response to the authentication request according to whether the series of questions includes one or more signatures in the database.

17. The method of claim 12 wherein the determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid includes:
consulting the one or more predetermined discrete authentication parameters, the one or more predetermined discrete authentication parameters including one or more of a dollar amount, an event, and/or a discrete occurrence relative to an authentication entity.

18. The method of claim 12 wherein the determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid includes: receiving from the user an identification, the identification providing a mapping to the one or more predetermined discrete authentication parameters.

19. The method of claim 12 further comprising:
pregenerating one or more questions for the series of questions after a successful authentication takes place, the pregenerating one or more questions including generating one or more derivative questions based on the series of questions and based on a status of the predetermined discrete authentication parameters.

20. The method of claim 19 wherein the pregenerating one or more questions for the series of questions after a successful authentication takes place, the pregenerating one or more questions including generating one or more derivative questions based on the series of questions and based on a status of the predetermined discrete authentication parameters includes:
determining the status of the predetermined discrete authentication parameters by receiving an update via a computationally networked entity concerning one or more of an event occurrence, an alteration of status of the user with respect to the computationally networked entity, and/or an alteration of status of the computationally networked entity.

21-42. (canceled)

43. A voice-capable system comprising:
a processor;
audio input and/or output circuitry coupled to the processor;
a memory coupled to the processor; and
a security module coupled to the processor, the security module configured to implement a secure protocol, the secure protocol configured to implement an automated system with one or more questions related to security/authentication, the security module configured to include:
an access module for receiving an authentication request by the voice-capable system from a user computationally networked to the voice-capable system;
a time authentication module for determining an authentication session in response to the authentication request, the determining the authentication session including identifying a series of questions associated with the user, the series of questions determined via consulting a predetermined period of time configured to prevent one or more questions from the series of questions from being reused until the predetermined period of time has elapsed; and/or
a discrete parameter authentication generation module for determining an authentication session in response to the authentication request, the determining the authentication session including identifying a series of questions associated with the user, the series of questions determined via consulting one or more predetermined discrete authentication parameters configured to prevent one or more questions from the series of questions from being reused until the one or more predetermined discrete authentication parameters become invalid.

44. The voice-capable system of claim 43 wherein the security module is coupled to the processor, located within the processor, and/or located in the memory.

45. The voice-capable system of claim 43 wherein the memory is one or more of a random access memory, a read only memory, an optical memory, or a subscriber identity module memory.

46. The voice-capable system of claim 43 wherein the audio input and/or output circuitry includes one or more of a microphone, a speaker, a transducer, and/or audio input and/or output circuitry.

47. The voice-capable system of claim 43 further comprising a housing coupled to the processor, the housing encasing the memory, the processor, and/or the audio input and/or output circuitry.
